(19) United States
(12) Patent Application Publication
(10) Pub. No.: US 2025/0116072 A1
(43) Pub. Date: Apr. 10, 2025

(54) Travel Restrictor

(71) Applicant: Daifukiu Co., Ltd., Osaka-shi (JP)

(72) Inventor: Tomohiko Kawashima, Hinocho (JP)

(21) Appl. No.: 18/910,768

(22) Filed: Oct. 9, 2024

(30) Foreign Application Priority Data
Oct. 10, 2023 (JP) 2023-175526

(51) Int. Cl. E01B 26/00; E01B 25/02

(52) U.S. Cl. CPC E01B 26/00; E01B 25/02

(57) ABSTRACT

A travel restrictor restricts travel of a transport vehicle in a transport facility. The transport facility includes a travel rail and the transport vehicle including a wheel to roll on a travel surface of the travel rail, a drive for the wheel, and a bumper. The travel restrictor includes a body, an engagement member, and a connector. The body has a facing surface disposed to face the bumper with the body placed on the travel surface, and a supportable portion being a portion supportable by the travel surface when the facing surface is pressed by the bumper. The engagement member is in contact with a lower rail surface at a position farther on an approaching side in a travel direction than the facing surface and the supportable portion when the facing surface is pressed by the bumper.

### CROSS-REFERENCE TO RELATED APPLICATION

This application claims priority to Japanese Patent Application No. 2023-175526 filed Oct. 10, 2023, the disclosure of which is hereby incorporated by reference in its entirety.

### BACKGROUND OF THE INVENTION

### Technical Field

The present invention relates to a travel restrictor.

### Description of Related Art

For example, WO 2014/129066 describes a technique for a travel restrictor. Reference signs in parentheses used hereafter in describing the background are the reference signs in WO 2014/129066.

An automated warehouse described in WO 2014/129066 uses a transport vehicle (a stacker crane 2) as a transporter to transport articles. This transport vehicle includes a lower carriage (4) to be guided by a lower rail (12), an upper carriage (6) to be guided by an upper rail (14), a mast (8) fixed to the lower carriage (4) and connecting the lower carriage (4) and the upper carriage (6), and a transferrer (10) attached to the mast (8). The lower carriage (4) includes a wheel (a drive wheel 22) that rolls on the upper surface of the lower rail (12) and a support (28) disposed apart from the wheel. The lower carriage (4) also includes a displacement assembly. The displacement assembly raises and lowers the support (28) between a grounded position at which the support is supported by the lower rail (12) and a retracted position at which the support is raised above the lower rail (12). The support (28) is raised to the retracted position to operate the transport vehicle. The support (28) is lowered to the grounded position to install the transport vehicle on the lower rail (12) and the upper rail (14), or to stop the transport vehicle for maintenance.

In the automated warehouse described in WO 2014/129066, the orientations of the lower carriage (4) and the mast (8) can be stabilized by lowering the support (28) to the grounded position. This facilitates installation of the transport vehicle on the rails and maintenance of the transport vehicle. However, an operator may move the transport vehicle during such work, and the transport vehicle may start traveling unintentionally while being moved. In this case, the transport vehicle is to be stopped immediately to ensure the operator's safety and prevent damage to the equipment. WO 2014/129066 does not describe such a case.

### SUMMARY OF THE INVENTION

One or more aspects are directed to a travel restrictor that can stop a transport vehicle promptly for emergency when the transport vehicle starts traveling unintentionally.

A travel restrictor according to an aspect of the disclosure restricts travel of a transport vehicle in a transport facility including a travel rail and the transport vehicle. The travel rail has a travel surface facing upward and a lower rail surface disposed below the travel surface and facing downward. The transport vehicle includes a wheel to roll on the travel surface of the travel rail, a drive for the wheel, and a bumper disposed above the travel surface to stop the drive upon colliding with an obstacle. The transport vehicle travels along the travel rail. The travel restrictor includes a body placeable on the travel surface, at least one engagement member disposed to face the lower rail surface, and at least one connector integrally connecting the body and the at least one engagement member outside the travel surface in a width direction perpendicular to a travel direction being a direction along the travel rail when viewed in a vertical direction. The body includes a facing surface disposed to face the bumper from a separating side away from the bumper in the travel direction with the body placed on the travel surface, and a supportable portion supportable by the travel surface when the facing surface is pressed toward the separating side in the travel direction by the bumper. The at least one engagement member is in contact with the lower rail surface at a position farther on an approaching side toward the bumper in the travel direction than the facing surface and the supportable portion when the facing surface is pressed by the bumper toward the separating side in the travel direction.

In this structure, when the transport vehicle travels unintentionally and the facing surface is pressed by the bumper, the body is supported by the travel surface with the supportable portion, and the engagement member is in contact with the lower rail surface and is pressed at a position farther on the approaching side in the travel direction than the facing surface and the supportable portion. With a pressing force from the bumper applied on the facing surface, the engagement member is pressed against the lower rail surface and produces a frictional force, allowing the travel restrictor to be fixed to the travel rail. This allows the facing surface to push the bumper and reliably stop the drive in the transport vehicle for emergency.

This structure also allows the travel restrictor to be easily installed on the travel rail by placing the body on the travel surface with the engagement member facing the lower rail surface.

This structure fixes the travel restrictor to the travel rail using the frictional force generated with the travel rail and the pressing force from the bumper applied on the facing surface. This further allows the travel restrictor, after stopping the transport vehicle, to be easily removed from the travel rail by detaching the engagement member from the lower rail surface.

Further aspects and advantages of the travel restrictor will be apparent from exemplary and nonlimiting embodiments described below with reference to the drawings.

### BRIEF DESCRIPTION OF THE DRAWINGS

FIG. 1 is a schematic plan view of a travel carriage in a transport vehicle.

FIG. 2 is a control block diagram.

FIG. 3 is a perspective view of a travel restrictor.

FIG. 4 is a rear view of the travel restrictor.

FIG. 5 is a schematic side view of a bumper pressing a facing surface of the travel restrictor.

FIG. 6 is a rear view of a travel restrictor according to another embodiment.

### DETAILED DESCRIPTION OF THE INVENTION

A travel restrictor according to one or more embodiments used for a transporter will now be described with reference to the drawings.

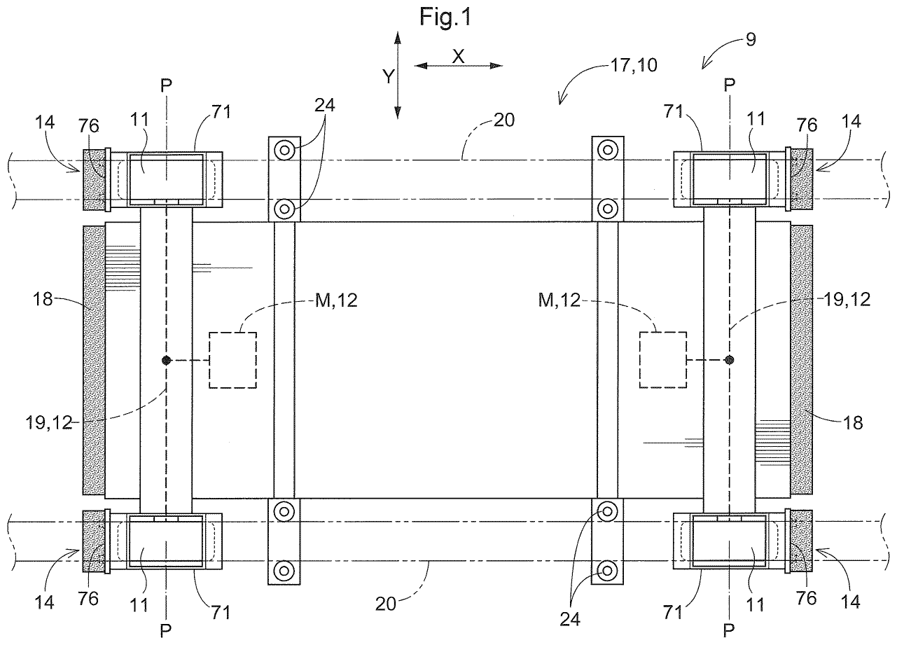

As shown in FIGS. 1 to 4, a transport facility 9 includes travel rails 20 and a transport vehicle 10 that travels along the travel rails 20. In the present embodiment, the transport facility 9 transports articles. More specifically, the transport vehicle 10 is an article transport vehicle that travels along the travel rails 20 to transport articles to a predetermined destination. The transport facility 9 is, for example, disposed inside an automated warehouse that includes storage shelves storing multiple articles, and moves the articles inside and outside the storage shelves.

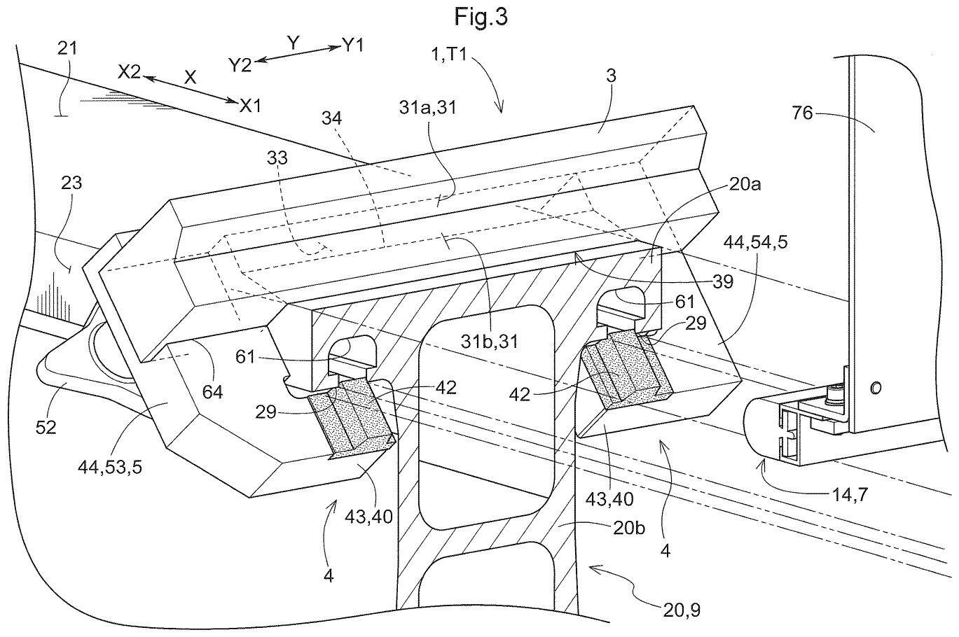

In the present embodiment, as shown in FIGS. 3 to 5, each travel rail 20 has a travel surface 21 facing upward and lower rail surfaces 29 disposed below the travel surface 21 and facing downward. In the present embodiment, each travel rail 20 includes a rail body 20a and a rail support 20b that supports the rail body 20a from below. The rail support 20b is disposed, for example, on a floor of the transport facility 9. The travel surface 21 is a surface of the rail body 20a facing upward. The lower rail surfaces 29 are surfaces of the rail body 20a facing downward. In the example in the figures, the lower rail surfaces 29 are disposed on areas of the rail body 20a other than a joint between the rail body 20a and the rail support 20b. More specifically, the rail body 20a has a larger dimension than the rail support 20b in a width direction Y, and the lower rail surfaces 29 are disposed, as a pair, separately in the width direction Y across the joint. In the example in the figures, the pair of lower rail surfaces 29 each include a groove 61 recessed upward. The grooves 61 are disposed in a direction in which the travel rails 20 extend.

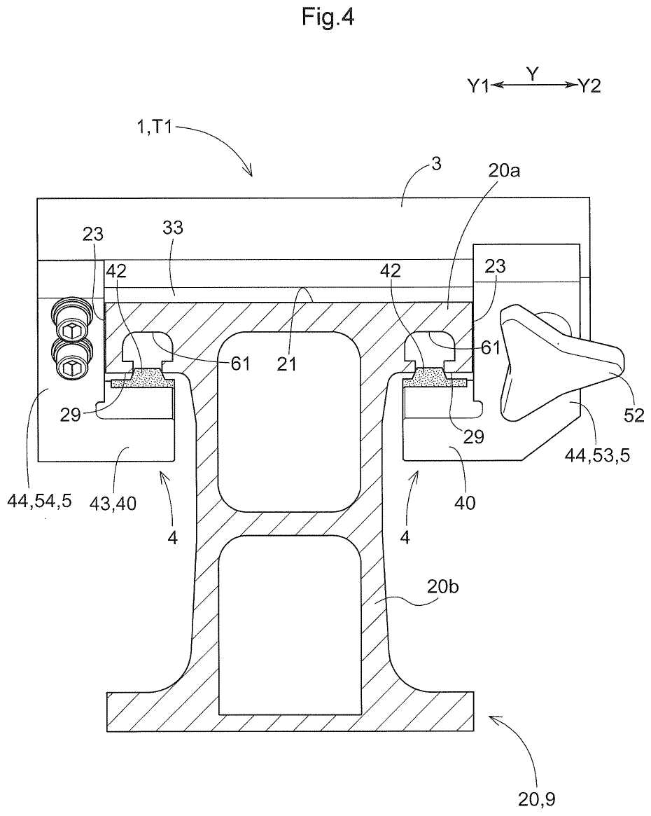

In the present embodiment, as shown in FIGS. 1 and 4, a pair of travel rails 20 are disposed separately in the width direction Y. The transport vehicle 10 is guided by the pair of travel rails 20 to travel in a travel direction X. The direction along the travel rails 20 is hereafter referred to as the travel direction X, and the direction perpendicular to the travel direction X when viewed in the vertical direction is hereafter referred to as the width direction Y. The travel direction X includes a separating side X2 away from a first bumper 14 in the travel direction and an approaching side X1 toward the first bumper 14 in the travel direction. The width direction Y includes a first side Y1 in the width direction and a second side Y2 opposite to the first side Y1 in the width direction.

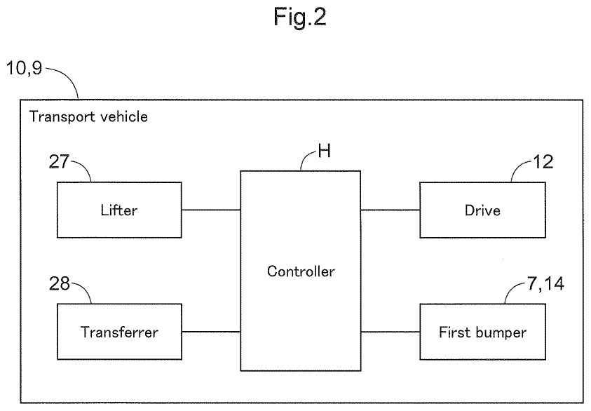

As shown in FIGS. 1 and 2, the transport vehicle 10 includes wheels 11 that roll on the travel surfaces 21 of the travel rails 20, drives 12 for the wheels 11, and the first bumpers 14 arranged above the travel surfaces 21 to stop the drives 12 upon colliding with an obstacle. In the present embodiment, the transport vehicle 10 further includes second bumpers 18. The first bumpers 14 each correspond to a bumper.

In the present embodiment, as shown in FIG. 1, the transport vehicle 10 includes the multiple (four in this example) wheels 11 arranged separately in the travel direction X and in the width direction Y to correspond to the pair of travel rails 20. As shown in FIGS. 1 and 2, the transport vehicle 10 also includes a travel carriage 17 that moves as guided by the travel rails 20, a transferrer 28 that transfers an article to be transported, a lifter 27 that lifts and lowers the article, and a controller H that controls the entire transport vehicle 10. The travel carriage 17 includes the wheels 11 described above, and accommodates the drives 12 that drive the wheels 11 and the controller H.

The drives 12 each drive at least one of the multiple wheels 11. As shown in FIG. 1, the drives 12 each include a travel motor M and a transmission 19 that transmits a driving force from the travel motor M to at least one of the wheels 11. In the example in the figure, the multiple drives 12 are arranged to correspond to the wheels 11 arranged separately in the drive direction X (i.e., the wheels 11 at the front and the wheels 11 at the rear in the travel direction X). In the example in FIG. 1, the travel carriage 17 includes multiple guide wheels 24 that correspond to the pair of travel rails 20. Each travel rail 20 has rail side surfaces 23 on its opposite sides in the width direction Y, and the multiple guide wheels 24 each roll on either of the rail side surfaces 23 of a travel rail 20 in the width direction Y. In the present embodiment, the rail side surfaces 23 are opposite side surfaces of the rail body 20a in the width direction Y. In the present embodiment, wheel supports 71 are arranged to correspond to the multiple wheels 11. In the example in FIG. 1, the wheel supports 71 are included in the travel carriage 17.

Each wheel support 71 supports a wheel 11 in a manner rotatable about an axis P extending in the width direction Y. Each wheel support 71 covers, from outside, opposite sides of the corresponding wheel 11 in the travel direction X and a side (the side farther from the travel carriage 17) of the wheel 11 in the width direction Y.

The transferrer 28 holds an article during transportation and transfers the article to and from a transfer area. The transferrer 28 receives and holds the article, and moves the article to and from the transfer area in the width direction Y to transfer the article. In the present embodiment, the transferrer 28 includes a conveyor, but may include, for example, a slide fork. The transferrer 28 is included in the lifter 27. In the present embodiment, the transport vehicle 10 is a stacker crane. The travel carriage 17 thus includes a mast (not shown) extending in the vertical direction. The lifter 27 can ascend and descend along the mast.

The transport vehicle 10 is not limited to a stacker crane, but may be a transport carriage (shuttle carriage) that receives and transports articles. In this case, the transferrer 28 may be included in the travel carriage 17. The transport vehicle 10 may be a primary carriage on which a secondary carriage that travels in the width direction Y to transport articles is placed, or may be a ceiling-hung transport vehicle that travels as guided by a rail hung from a ceiling.

The multiple first bumpers 14 are arranged to correspond to the multiple (four in this example,) wheels 11. Each first bumper 14 is disposed outside the corresponding wheel 11 in the travel direction X (on the separating side X2 in the travel direction). In the present embodiment, each first bumper 14 is fixed to the corresponding wheel support 71 with a bumper support 76. Each first bumper 14 is disposed to protrude toward the separating side X2 in the travel direction relative to the travel carriage 17 when viewed in the vertical direction. In the present embodiment, the first bumpers 14 are arranged above the travel rails 20 (or more specifically, the travel surfaces 21). When an object such as an obstacle is located on a travel rail 20 frontward from the transport vehicle 10 in the travel direction, typically the first bumper 14 comes in contact with the object.

As shown in FIG. 2, the transport vehicle 10 further includes a switch 7. The switch 7 is turned on when, for example, an object such as an obstacle on a travel rail 20 frontward from the transport vehicle 10 in the travel direction collides with the first bumper 14. The switch 7 switching from an off-state to an off-state interrupts power supply to the drives 12 and causes the transport vehicle 10 to stop. In the present embodiment, the first bumpers 14 serve as switches. In other words, the first bumpers 14 are the switches 7. More specifically, when the transport vehicle 10 is traveling, and an end of the first bumper 14 comes in contact with another object and is pressed inward (toward the approaching side X1 in the travel direction), the transport vehicle 10 stops. With such switch function, the bumpers 14 that protect the wheels 11, the wheel supports 71, and the travel carriage 17 from the impact of colliding can also cause the transport vehicle 10 to stop for emergency when the transport vehicle 10 collides with an object on a travel rail 20. The switch 7 may be separate from the first bumpers 14. For example, the switch 7 may be included in the travel carriage 17 or the wheel supports 71.

The second bumpers 18 are arranged outside opposite sides of the travel carriage 17 in the travel direction X. The second bumpers 18 are disposed between the pair of travel rails 20. In the example in FIG. 1, each second bumper 18 is disposed between a pair of first bumpers 14 arranged separately in the width direction Y. The second bumpers 18 serve in the same manner as the first bumpers 14. More specifically, the second bumpers 18 each protect components including the travel carriage 17 and cause the transport vehicle 10 to stop for emergency when the transport vehicle 10 collides with an obstacle. More specifically, when the transport vehicle 10 is traveling, and the end of a second bumper 18 comes in contact with another object and is pushed inward (toward the approaching side X1 in the travel direction), the transport vehicle 10 stops. The second bumpers 18 may not serve as the switches.

The controller H receives, for example, command information from a host controller that controls the entire automated warehouse (not shown) to control the lifter 27, the transferrer 28, and the drives 12 based on the command information. The controller H interrupts the power supply to the drives 12 to stop the transport vehicle 10 when the first bumper 14 switches from the off-state to the on-state. The controller H includes a processor such as a microcomputer and a peripheral circuit such as a memory. The controller H implements its functions in cooperation between these pieces of hardware and programs executed on the hardware such as the processor.

As shown in FIGS. 3 to 5, a travel restrictor 1 restricts travel of the transport vehicle 10. The travel restrictor 1 is supported by a travel surface 21 of a travel rail 20 to prevent the transport vehicle 10 from traveling beyond the travel restrictor 1. More specifically, the travel restrictor 1 is disposed on the separating side X2 in the travel direction relative to the first bumper 14 in the transport vehicle 10 to face the first bumper 14. For example, an operator may place the travel restrictor 1 on the travel rail 20 during maintenance of the transport vehicle 10.

As shown in FIGS. 3 and 4, the travel restrictor 1 includes a body 3 placed on a travel surface 21, engagement members 4 arranged to face the corresponding lower rail surfaces 29, and connectors 5 that each integrally connect the body 3 and the corresponding engagement member 4 outside the travel surface 21 in the width direction Y. In the present embodiment, each connector 5 is supported by the body 3 and connects the body 3 and an engagement member 4 to support the engagement member 4.

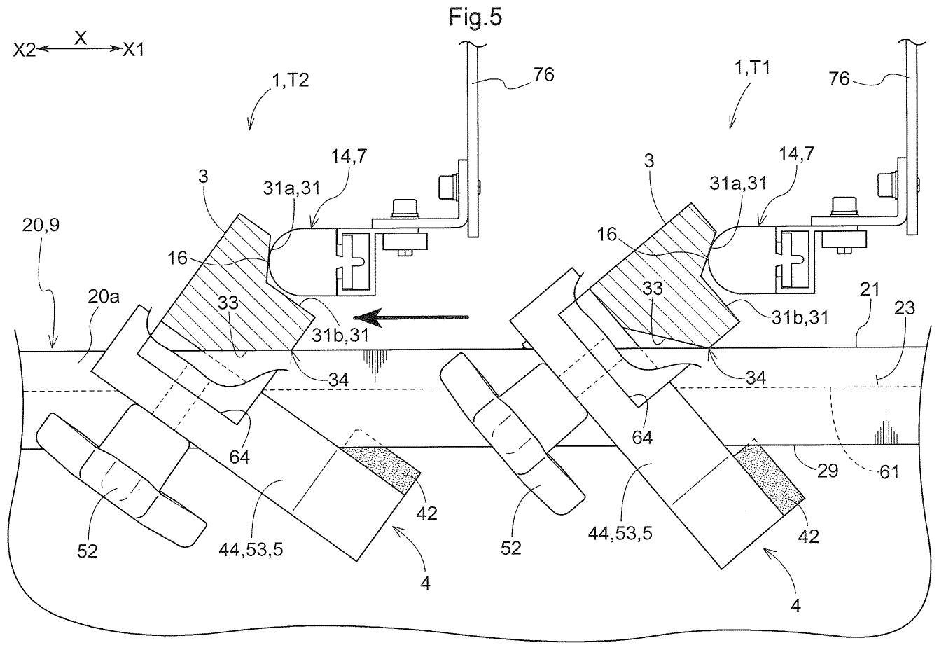

As shown in FIGS. 3 to 5, the body 3 includes a facing surface 31 disposed to face a first bumper 14 from the separating side X2 in the travel direction when placed on the travel surface 21, and a supportable portion 34 supportable by the travel surface 21 when the facing surface 31 is pressed by the first bumper 14 toward the separating side X2 in the travel direction. The body 3 also includes a bottom surface 33 to be parallel to the travel surface 21 when the facing surface 31 pressed by the first bumper 14 causes the engagement members 4 to be in contact with the lower rail surfaces 29. In the present embodiment, the body 3 is a columnar member extending in the width direction Y. In the present embodiment, the body 3 has a larger dimension than the travel rail 20 in the width direction Y. The orientation of the travel restrictor 1 placed correctly on the travel rail 20 (shown on the right in FIG. 5) is hereafter referred to as a reference orientation T1. In the present embodiment, as shown in FIG. 5, the travel restrictor 1 in the reference orientation T1 has the supportable portion 34 in contact with the travel surface 21 and has the bottom surface 33 inclined without being in contact with the travel surface 21. The orientation of the travel restrictor 1 having the entire bottom surface 33 in contact with the travel surface 21 with the facing surface 31 pressed by the first bumper 14 (shown on the left in FIG. 5) is hereafter referred to as a rotated orientation T2.

The facing surface 31 is a surface of the body 3 facing the approaching side X1 in the travel direction in the reference orientation T1. The facing surface 31 comes in contact with the first bumper 14 when the transport vehicle 10 travels. In the present embodiment, as shown in FIGS. 3 and 5, the facing surface 31 is recessed toward the separating side X2 in the travel direction to receive an end 16 of the first bumper 14 on the separating side X2 in the travel direction. In the present embodiment, as shown in FIGS. 3 and 5, the facing surface 31 is recessed to fit the shape of the end 16 of the first bumper 14. The facing surface 31 includes multiple surfaces (inclined surfaces in this example). More specifically, the facing surface 31 includes an upper facing surface 31a and a lower facing surface 31b. The upper facing surface 31a is an inclined surface extending in the width direction Y and inclined toward the separating side X2 in the travel direction toward its lower end. The lower facing surface 31b is an inclined surface continuous with the lower end of the upper facing surface 31a and inclined toward the approaching side X1 in the travel direction toward its lower end. In other words, the facing surface 31 is a recess with the joint between the upper facing surface 31a and the lower facing surface 31b recessed the farthest toward the separating side X2 in the travel direction. In the example in the figures, the first bumper 14 is an arc protruding toward the separating side X2 in the travel direction when viewed in the width direction Y. When the transport vehicle 10 travels, the end 16 and a portion above the end 16 of the first bumper 14 come in contact with and press the upper facing surface 31a. The facing surface 31 may not include multiple surfaces, and may be a single curved surface.

The bottom surface 33 is in contact with the travel surface 21 when the travel restrictor 1 is in the rotated orientation T2. In other words, the bottom surface 33 is the surface of the body 3 facing downward (the surface disposed at the lowermost position) in the rotated orientation T2. In the rotated orientation T2, the bottom surface 33 is ideally in surface contact with the travel surface 21, but may not be precisely in surface contact. In the present embodiment, the bottom surface 33 is disposed in an area of the main body 3 that overlaps the travel surface 21 when viewed in the vertical direction, but not disposed in opposite end areas of the body 3 (in the figure, areas disposed outside the opposite sides of the travel rail 20 in the width direction Y).

In the present embodiment, as shown in FIGS. 3 and 5, the supportable portion 34 includes an edge of the bottom surface 33 on the approaching side X1 in the travel direction. When the facing surface 31 is pressed by the first bumper 14, the body 3 rotates about an axis extending in the width direction Y with the supportable portion 34 as a fulcrum. In the present embodiment, in the reference orientation T1, the bottom surface 33 is an inclined surface inclined upward toward the separating side X2 in the travel direction, and no portion of the bottom surface 33 other than the supportable portion 34 is in contact with the travel surface 21. When the facing surface 31 is pressed by the first bumper 14, the body 3 rotates with the supportable portion 34 as a fulcrum, causing the entire bottom surface 33 to rotate to be in contact with the travel surface 21. The bottom surface 33 is thus parallel to the travel surface 21 in the rotated orientation T2.

The engagement members 4 are arranged below the travel surface 21 and on the approaching side X1 in the travel direction relative to the body 3 when the travel restrictor 1 is in the reference orientation T1 or in the rotated orientation T2. The engagement members 4 are disposed to overlap the travel rail 20 (e.g., the travel surface 21 and the respective lower rail surfaces 29) when viewed in the vertical direction. When the facing surface 31 is pressed by the first bumper 14 toward the separating side X2 in the travel direction, the engagement members 4 are in contact with the respective lower rail surfaces 29 at positions on the approaching side X1 in the travel direction relative to the facing surface 31 and the supportable portion 34. The engagement members 4 rotate about the axis extending in the width direction Y with the supportable portion 34 as a fulcrum. The engagement members 4 rotate integrally with the body 3 described above. In the present embodiment, the travel restrictor 1 includes a pair of engagement members 4. The pair of engagement members 4 are arranged separately in the width direction Y. In the present embodiment, the pair of engagement members 4 are arranged to correspond to the pair of lower rail surfaces 29 disposed separately in the width direction Y. The pair of engagement members 4 are to be in contact with the pair of lower rail surfaces 29 from below. In the present embodiment, the pair of engagement members 4 have the same structure.

In the present embodiment, as shown in FIGS. 3 to 5, each engagement member 4 includes a contact portion 42 to be in contact with the corresponding lower rail surface 29. At least the contact portion 42 is attachable to and detachable from a target portion 40 being either the connector 5, or a portion other than the contact portion 42 in the engagement member 4 (hereafter referred to as an engagement member body 43). In the present embodiment, each engagement member 4 includes the contact portion 42 and the engagement member body 43 supporting the contact portion 42. In the present embodiment, the engagement member body 43 serves as the target portion 40. In other words, the contact portion 42 is attachable to and detachable from the engagement member body 43. The engagement member body 43 connects the contact portion 42 and the connector 5 and supports the contact portion 42. In the example in the figures, the engagement member bodies 43 support the respective contact portions 42 from below. The contact portions 42 may be fixed to the respective engagement member bodies 43 with, for example, a fastener. The contact portions 42 may be fixed to the respective engagement member bodies 43 by a fitting assembly, or a combination of these. In the present embodiment, the contact portions 42 are elastic members (e.g., synthetic rubber members). The contact portion 42 have a shape based on the lower rail surfaces 29. In the example in the figures, the lower rail surfaces 29 each include a groove 61. The contact portions 42 each have a protrusion to engage with the corresponding groove 61. The contact portions 42 may be, for example, knurled metal members. The shape of the contact portions 42 may be changed as appropriate based on the shape of the lower rail surfaces 29.

In the example in FIGS. 3 to 5, the contact portions 42 are in contact with the respective lower rail surfaces 29 and engaged with the respective grooves 61 in the reference orientation T1. The contact portions 42 are each an elastic member with a protrusion having a dimension decreasing upward in the width direction Y. The contact portions 42 each have an upper end having a slightly larger dimension than the corresponding groove 61 in the width direction Y. Thus, in the reference orientation T1, the contact portions 42 have the upper end portions in contact with the lower rail surfaces 29 and engaged with the grooves 61.

As shown in FIGS. 3 and 4, the travel restrictor 1 includes the pair of connectors 5 corresponding to the pair of engagement members 4. The pair of connectors 5 are arranged outside the opposite sides of the travel rail 20 in the width direction Y. Each of the pair of connectors 5 is disposed to connect an end portion of the body 3 in the width direction Y and the corresponding engagement member 4. Of the pair of connectors 5, the connector 5 disposed on the first side Y1 in the width direction may be referred to as a first connector 54, and the connector 5 disposed on the second side Y2 in the width direction as a second connector 53. In the present embodiment, the pair of connectors 5 hold the travel rail 20 from opposite sides in the width direction Y with the body 3 placed on the travel surface 21. In the present embodiment, the connectors 5 each face the corresponding rail side surface 23 with a small gap between them in the width direction Y. This can prevent each of the pair of connectors 5 from interfering with the travel rail 20 when the body 3 is placed on the travel surface 21.

The connectors 5 are arranged to be inclined downward toward the approaching side X1 in the travel direction in the reference orientation T1 and in the rotated orientation T2. The connectors 5 extend from below the lower rail surfaces 29 to above the travel surface 21 when viewed in the width direction Y. In the present embodiment, the first connector 54 is fixed to an end portion of the body 3 on the first side Y1 in the width direction. The engagement member body 43 in the corresponding engagement member 4 is connected to an end portion (lower end portion) of the first connector 54. In this case, the first connector 54 and the engagement member body 43 are integral with each other. The engagement member body 43 is disposed to protrude from the end portion of the first connector 54 inward in the width direction Y (toward the first side Y1 in the width direction in this example). The contact portion 42 is attached to a surface of the engagement member body 43 facing upward (a surface facing upward and facing the approaching side X1 in the travel direction in this example). In the present embodiment, at least one of the pair of connectors 5 is attachable to and detachable from the body 3. In the present embodiment, the second connector 53 is attachable to and detachable from the body 3. In the present embodiment, the second connector 53 is fixed to an end portion of the body 3 on the second side Y2 in the width direction in a detachable manner. The remaining structure of the second connector 53 is the same as the first connector 54 and will not be described. A structure in which the second connector 53 is attachable to and detachable from the body 3 will now be described. In the example in FIG. 4, the first connector 54 is fixed to the body 3 with a fastener, but may be fixed by, for example, welding.

In the example in FIGS. 3 to 5, a fitting groove 64 that is open upward in the width direction Y and is disposed near the upper end of the second connector 53. The fitting groove 64 receives the end portion of the body 3 in the second side Y2 in the width direction. In the example in the figures, with the body 3 fitted in the fitting groove 64, the second connector 53 and the body 3 are fixed by fastening with a fastener 52 (FIG. 5). The fitting groove 64 and the body 3 each has a hole in the end portion on the second side Y2 in the width direction to receive the fastener 52. A knob is attached to the fastener 52. With the knob on the fastener 52, the second connector 53 can be easily detached from the body 3, allowing the travel restrictor 1 in the rotated orientation T2 to be easily detached from the travel rail 20. This can improve work efficiency after stopping the transport vehicle 10 traveling unintentionally.

In the present embodiment, the travel restrictor 1 further includes a pair of width direction guides 44 integrally fixed to the body 3 and arranged to face the pair of rail side surfaces 23 from outside on opposite sides in the width direction Y to restrict the movement of the body 3 in the width direction Y. At least one of the pair of width direction guides 44 also serves as the connector 5. In the present embodiment, the pair of width direction guides 44 serve as the connectors 5. In other words, of the pair of width direction guides 44, the width direction guide 44 disposed on the first side Y1 in the width direction is the first connector 54, and the width direction guide 44 disposed on the second side Y2 in the width direction is the second connector 53. The pair of width direction guides 44 (the pair of connectors 5 in this case) each face the corresponding rail side surface 23 with a small gap between them in the width direction Y. This facilitates positioning of the body 3 in the width direction Y when the body 3 is placed on the travel surface 21. This also restricts the movement of the travel restrictor 1 in the width direction Y when the body 3 is placed in the reference orientation T1. The travel restrictor 1 is thus prevented from falling from the travel rail 20 when changing the orientation from the reference orientation T1 to the rotated orientation T2 with the facing surface 31 pressed by the first bumper 14. In the present embodiment, as described above, the second connector 53 is attachable to and detachable from the body 3. Thus, of the pair of width direction guides 44, the width direction guide 44 disposed on the second side Y2 in the width direction is attachable to and detachable from the body 3.

As shown in FIG. 5, when the travel restrictor 1 is in the reference orientation T1, the supportable portion 34 is in contact with the travel surface 21, and the engagement members 4 (the pair of engagement members 4 in this case) are in contact with and engage with the lower rail surfaces 29. The travel restrictor 1 thus maintains the reference orientation T1. When the transport vehicle 10 is traveling and the facing surface 31 (the upper facing surface 31a in this example) is pressed by the first bumper 14, the travel restrictor 1 moves toward the separating side X2 in the travel direction and rotates about the axis extending in the width direction Y with the supportable portion 34 as a fulcrum, changing the orientation from the reference orientation T1 to the rotated orientation T2. In the rotated orientation T2, the entire bottom surface 33 of the body 3 is in contact with the travel surface 21. The contact portions 42 in the engagement members 4 is fitted in and engage with the grooves 61 in the lower rail surfaces 29. The travel restrictor 1 thus stops rotating in the rotated orientation T2. This causes the upper facing surface 31a to be more upright than in the reference orientation T1. Under a reaction force from the facing surface 31, the first bumper 14 is pressed toward the approaching side X1 in the travel direction relative to the upper facing surface 31a, causing the drives 12 in the transport vehicle 10 to stop. In the present embodiment, the contact portions 42 in the engagement members 4 come in contact with the lower rail surfaces 29 and engage with the grooves 61, but the structure is not limited to this example. For example, for the lower rail surfaces 29 without the grooves 61, the contact portions 42 that are elastic members come in contact with and press the lower rail surfaces 29 from below while deforming elastically to cause the engagement members 4 to engage with the lower rail surfaces 29.

### Other Embodiments

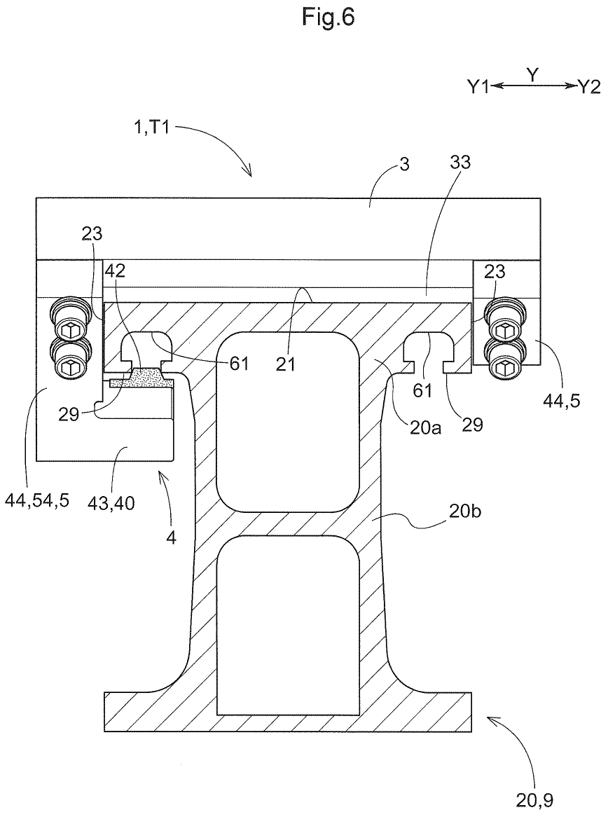

(1) In the above embodiment, the travel carriage 17 travels as guided by the pair of travel rails 20, but may travel differently. For example, the travel carriage 17 may travel as guided by a single travel rail 20.
(2) In the above embodiment, the body 3 and the connectors 5 are separate components, and the contact portions 42 in the engagement members 4 are separate components from the respective connectors 5, but the structure is not limited to this example. For example, the body 3, the connectors 5, and the engagement members 4 may be separate components, or may all be integral with one another.
(3) In the above embodiment, the facing surface 31 is recessed toward the separating side X2 in the travel direction, but may have a different shape. The facing surface 31 may be, for example, planar in the vertical direction and in the width direction Y. As described above, the shape of the facing surface 31 may be changed as appropriate.
(4) In the above embodiment, the supportable portion 34 includes the edge of the bottom surface 33 on the approaching side X1 in the travel direction, but the structure is not limited to this example. For example, the supportable portion 34 may include an edge of another surface not adjacent to the bottom surface 33. In another embodiment, the supportable portion 34 may be a surface in contact with the travel surface 21 in the reference orientation T1 shown in FIG. 5. In this case, the supportable portion 34 may have a relatively small dimension in the travel direction X to allow the travel restrictor 1 to change the orientation easily. As described above, the shape and the position of the supportable portion 34 may be changed as appropriate.
(5) In the above embodiment, each contact portion 42 is attachable to and detachable from the portion of the corresponding engagement member 4 other than the contact portion 42, but the structure is not limited to this example. For example, the entire engagement member 4 (the contact portion 42 and the engagement member body 43 in this example) may be attachable to and detachable from the corresponding connector 5. In this case, the connector 5 serves as the target portion 40.
(6) In the above embodiment, the pair of width direction guides 44 serve as the connectors 5, but the structure is not limited to this example. For example, the pair of width direction guides 44 may be separate components from the respective connector 5.
(7) In the above embodiment, at least one of the pair of connectors 5 is attachable to and detachable from the body 3, but the structure is not limited to this example. The pair of connectors 5 may be attachable to and detachable from the main body 3, or neither of the pair of connectors 5 may be attachable to and detachable from the main body 3.
(8) In the above embodiment, the travel restrictor 1 includes the pair of connectors 5 corresponding to the pair of engagement members 4, but the structure is not limited to this example. As shown in FIG. 6, a single connector 5 may be disposed only on a first side of the body 3 in the width direction Y relative to the travel surface 21 and be integral with the body 3. In the present embodiment, the travel restrictor 1 includes a single engagement member 4 engageable with the lower rail surface 29 disposed on the first side Y1 in the width direction, but includes no engagement member 4 engageable with the lower rail surface 29 disposed on the second side Y2 in the width direction. Thus, the first connector 54 connecting the engagement member 4 and the body 3 is disposed on the first side Y1 in the width direction, but the second connector 53 is eliminated. Additionally, as shown in FIG. 6, a width direction guide 44 integrally fixed to the body 3 is disposed on a second side of the body 3 in the width direction Y relative to the travel surface 21. The connector 5 and the width direction guide 44 hold the travel rail 20 from opposite sides in the width direction Y with the body 3 placed on the travel surface 21. In the present embodiment, the width direction guide 44 is disposed on the second side Y2 in the width direction relative to the travel surface 21, or on a side of the body 3 without the engagement member 4. More specifically, the width direction guide 44 is fixed to the end portion of the body 3 in the second side Y2 in the width direction. The first connector 54 and the width direction guide 44 hold the travel rail 20 (the rail body 20a in this case) from opposite sides in the width direction Y. In the example in FIG. 6, the first connector 54 serves as the width direction guide 44. In other words, the travel restrictor 1 includes a pair of width direction guides 44 arranged separately in the width direction Y.
(9) The structure described in each of the above embodiments may be combined with any other structures described in the other embodiments unless any contradiction arises. This also applies to combinations of the embodiments described as other embodiments. For other structures as well, the embodiments described herein are merely illustrative in all aspects. Thus, the embodiments described herein may be modified variously as appropriate without departing from the spirit and scope of the disclosure.

### Overview of Embodiments

An overview of the travel restrictor described above is provided below.

A travel restrictor according to an aspect of the disclosure restricts travel of a transport vehicle in a transport facility including a travel rail and the transport vehicle. The travel rail has a travel surface facing upward and a lower rail surface disposed below the travel surface and facing downward. The transport vehicle includes a wheel to roll on the travel surface of the travel rail, a drive for the wheel, and a bumper disposed above the travel surface to stop the drive upon colliding with an obstacle. The transport vehicle travels along the travel rail. The travel restrictor includes a body placeable on the travel surface, at least one engagement member disposed to face the lower rail surface, and at least one connector integrally connecting the body and the at least one engagement member outside the travel surface in a width direction perpendicular to a travel direction being a direction along the travel rail when viewed in a vertical direction. The body includes a facing surface disposed to face the bumper from a separating side away from the bumper in the travel direction with the body placed on the travel surface, and a supportable portion supportable by the travel surface when the facing surface is pressed toward the separating side in the travel direction by the bumper. The at least one engagement member is in contact with the lower rail surface at a position farther on an approaching side toward the bumper in the travel direction than the facing surface and the supportable portion when the facing surface is pressed by the bumper toward the separating side in the travel direction.

In this structure, when the transport vehicle travels unintentionally and the facing surface is pressed by the bumper, the body is supported by the travel surface with the supportable portion, and the engagement member is in contact with the lower rail surface and is pressed at a position farther on the approaching side in the travel direction than the facing surface and the supportable portion. With a pressing force from the bumper applied on the facing surface, the engagement member is pressed against the lower rail surface and produces a frictional force, allowing the travel restrictor to be fixed to the travel rail. This allows the facing surface to push the bumper and reliably stop the drive in the transport vehicle for emergency.

This structure also allows the travel restrictor to be easily installed on the travel rail by placing the body on the travel surface with the engagement member facing the lower rail surface.

This structure fixes the travel restrictor to the travel rail using the frictional force generated with the travel rail and the pressing force from the bumper applied on the facing surface. This further allows the travel restrictor, after stopping the transport vehicle, to be easily removed from the travel rail by detaching the engagement member from the lower rail surface.

The facing surface may be recessed toward the separating side in the travel direction to receive an end of the bumper on the separating side in the travel direction.

This structure can reduce the likelihood that the facing surface pressed by the bumper is not pressed appropriately due to the end of the bumper displaced in the vertical direction relative to the facing surface.

The travel restrictor can thus be fixed to the travel rail more reliably with the pressing force from the bumper applied on the facing surface.

The body may include a bottom surface to be parallel to the travel surface when the at least one engagement member is in contact with the lower rail surface with the facing surface pressed by the bumper. The supportable portion may include an edge of the bottom surface on the approaching side in the travel direction.

In this structure, the supportable portion includes the edge of the bottom surface of the body on the approaching side in the travel direction, thus simplifying the structure of the body.

In this structure, with the engagement member in contact with the lower rail surface, the bottom surface of the body is parallel to the travel surface, allowing a larger frictional force to be generated between the bottom surface of the body and the travel surface. The travel restrictor can thus be fixed to the travel rail with a larger force more easily.

In this structure, the body has a shape that can rotate easily with the supportable portion as a fulcrum, allowing the engagement member to be in contact with the lower rail surface with a larger force more easily. The travel restrictor can thus be fixed to the travel rail with an effectively increased force.

The at least one engagement member may include a contact portion to be in contact with the lower rail surface. At least the contact portion may be attachable to and detachable from a target portion being the at least one connector or a portion other than the contact portion in the at least one engagement member.

In this structure, the contact portion is replaceable with another contact surface when damaged through contact with the lower rail surface. With the contact portion that is more likely to be damaged being attachable to and detachable from the target portion, the entire travel restrictor is not to be replaced when the contact portion is damaged.

The travel restrictor may further include a pair of width direction guides integrally fixed to the body and arranged to face a pair of rail side surfaces being opposite side surfaces of the travel rail in the width direction from outside on opposite sides in the width direction to restrict movement of the body in the width direction. At least one of the pair of width direction guides may be the at least one connector.

This structure allows the travel restrictor to be easily disposed at an appropriate position on the travel rail in the width direction, and can restrict the travel restrictor from deviating in the width direction when the facing surface is pressed by the bumper. The engagement member can thus be in contact with the lower rail surface more reliably when the facing surface is pressed by the bumper.

The at least one engagement member may include a pair of engagement members. The at least one connector may include a pair of connectors respectively corresponding to the pair of engagement members. The pair of connectors may hold the travel rail from opposite sides in the width direction with the body placed on the travel surface. At least one of the pair of connectors may be attachable to and detachable from the body.

This structure includes the pair of connectors and the pair of engagement members connected to the body with the respective connectors. This allows the engagement members on opposite sides in the width direction to support the load equally in the width direction when the facing surface is pressed by the bumper. The travel restrictor can thus be fixed with the load from the bumper supported stably when the pressing force from the bumper is applied unevenly in the width direction on the facing surface.

In this structure, the pair of the connectors hold the travel rail from opposite sides in the width direction. This allows the travel restrictor to be easily disposed at an appropriate position on the travel rail in the width direction, and can restrict the travel restrictor from deviating in the width direction when the facing surface is pressed by the bumper.

This structure also allows the travel restrictor pressed by the bumper to be easily removed from the travel rail by removing at least one of the pair of connectors from the body.

The at least one connector may be disposed only on a first side in the width direction relative to the travel surface and be integral with the body. The travel restrictor may further include a width direction guide integrally fixed to the body on a second side in the width direction relative to the travel surface. The at least one connector and the width direction guide may hold the travel rail from opposite sides in the width direction with the body placed on the travel surface.

This structure includes the connector and the engagement member only on a single side in the width direction, allowing the travel restrictor to be installed on the travel rail more easily than in a structure including these components on opposite sides in the width direction.

In this structure, the connector and the width direction guide hold the travel rail from opposite sides in the width direction. This allows the travel restrictor to be easily disposed at an appropriate position on the travel rail in the width direction, and can restrict the travel restrictor from deviating in the width direction when the facing surface is pressed by the bumper.

This structure can thus achieve the easy installation of the travel restrictor on the travel rail and the positional stability of the travel restrictor when the facing surface is pressed by the bumper.

The travel restrictor according to one or more embodiments of the disclosure may produce at least one of the effects described above.

What is claimed is:

1. A travel restrictor for restricting travel of a transport vehicle in a transport facility, the transport facility comprising a travel rail and the transport vehicle, the travel rail having a travel surface facing upward and a lower rail surface disposed below the travel surface and facing downward, the transport vehicle comprising a wheel to roll on the travel surface of the travel rail, a drive for the wheel, and a bumper disposed above the travel surface to stop the drive upon colliding with an obstacle, the transport vehicle configured to travel along the travel rail, the travel restrictor comprising:
a body placeable on the travel surface;
at least one engagement member disposed to face the lower rail surface; and
at least one connector integrally connecting the body and the at least one engagement member outside the travel surface in a width direction perpendicular to a travel direction when viewed in a vertical direction, the travel direction being a direction along the travel rail, and
wherein:
the body comprises a facing surface and a supportable portion,
with the body placed on the travel surface, the facing surface is disposed to face the bumper from a separating side away from the bumper in the travel direction, and the supportable portion is supportable by the travel surface when the facing surface is pressed toward the separating side in the travel direction by the bumper,
the at least one engagement member is configured to be in contact with the lower rail surface at a position farther on an approaching side toward the bumper in the travel direction than the facing surface and the supportable portion when the facing surface is pressed by the bumper toward the separating side in the travel direction.

2. The travel restrictor according to claim 1, wherein:
the facing surface is recessed toward the separating side in the travel direction to receive an end of the bumper on the separating side in the travel direction.

3. The travel restrictor according to claim 1, wherein:
the body comprises a bottom surface to be parallel to the travel surface when the at least one engagement member is in contact with the lower rail surface with the facing surface pressed by the bumper, and
the supportable portion comprises an edge of the bottom surface on the approaching side in the travel direction.

4. The travel restrictor according to claim 1, wherein:
the at least one engagement member comprises a contact portion to be in contact with the lower rail surface, and at least the contact portion is attachable to and detachable from a target portion that is the at least one connector or a portion other than the contact portion in the at least one engagement member.

5. The travel restrictor according to claim 1, further comprising:
a pair of width direction guides integrally fixed to the body and arranged to face a pair of rail side surfaces from outside on opposite sides in the width direction to restrict movement of the body in the width direction, the pair of rail side surfaces being opposite side surfaces of the travel rail in the width direction, and
wherein at least one of the pair of width direction guides is the at least one connector.

6. The travel restrictor according to claim 1, wherein:
the at least one engagement member comprises a pair of engagement members, and the at least one connector comprises a pair of connectors respectively corresponding to the pair of engagement members,
the pair of connectors hold the travel rail from opposite sides in the width direction with the body placed on the travel surface, and
at least one of the pair of connectors is attachable to and detachable from the body.

7. The travel restrictor according to claim 1, wherein:
the at least one connector is disposed only on a first side in the width direction relative to the travel surface and is integral with the body,
the travel restrictor further comprises a width direction guide integrally fixed to the body on a second side in the width direction relative to the travel surface, and
the at least one connector and the width direction guide hold the travel rail from opposite sides in the width direction with the body placed on the travel surface.
